(19) United States
(12) Patent Application Publication
(10) Pub. No.: US 2024/0109042 A1
(43) Pub. Date: Apr. 4, 2024

(54) MIXING AND/OR SCRAPING ASSEMBLY FOR MIXING APPARATUS FOR FOOD, PHARMACEUTICAL OR COSMETIC PRODUCTS, AND MIXING APPARATUS COMPRISING SUCH AN ASSEMBLY

(71) Applicant: FIREX S.R.L, Sedico (BL) (IT)

(72) Inventors: Paolo CADORIN, Sedico (BL) (IT); Aldo PRALORAN, Sedico (BL) (IT)

(73) Assignee: FIREX S.R.L, Sedico (BL) (IT)

(21) Appl. No.: 18/373,786

(22) Filed: Sep. 27, 2023

(30) Foreign Application Priority Data
Oct. 4, 2022 (IT) 102022000020379

(51) Int. Cl. B01F 27/07; B01F 27/091; B01F 27/1124; B01F 27/90

(52) U.S. Cl. CPC B01F 27/071; B01F 27/091; B01F 27/1124; B01F 27/90; B01F 2101/06

(57) ABSTRACT

A mixing and/or scraping assembly mixes apparatus for food, pharmaceutical or cosmetic products, includes a mixing arm assembly and at least one mixing and/or scraping element that is removably connectable to each other. The mixing and/or scraping element is removably couplable with at least a first mixing arm and a second mixing arm by way of first and second anchors. In particular, at least one of the anchors is provided with a releasable clamping mechanism including a hook configured to receive at least a part of the respective mixing arm, and a clamping element movable between a closed position in which it prevents insertion and extraction of the mixing arm into/from the hook, and an open position in which it is suitable for allowing insertion and extraction of the mixing arm into/from the hook.

### TECHNICAL FIELD OF THE INVENTION

The present invention relates to a mixing and/or scraping assembly for a mixing apparatus for food, pharmaceutical or cosmetic products. In addition, the present invention relates to a mixing apparatus comprising said mixing and/or scraping assembly.

### STATE OF THE PRIOR ART

Mixing apparatuses for food, pharmaceutical or cosmetic products are known in the state of the art. In a known type of mixing apparatus, mixing of products may take place at room temperature conditions or before and/or during and/or after a heat treatment, such as the cooking of a food product, which is performed by heating devices associated with the mixing apparatus.

The document U.S. Pat. No. 5,615,951 describes an example of a food mixing apparatus. Such a mixing apparatus comprises a processing tank in which a rotating shaft, typically motor-driven, is mounted. One or more mixing arms in turn equipped with one or more mixing elements, such as mixing grids, are attached to the rotating shaft. In particular, the mixing apparatus is configured to provide a desired mixing capacity of the food product through said mixing elements.

Although such well-known mixing apparatuses work adequately in many cases, they nevertheless have drawbacks.

In fact, particularly in the case of professional or industrial mixing apparatuses, the mixing elements must be replaced at high frequency, depending on the intensity of use of the mixing apparatus and/or the characteristics of a given product and/or the cleaning procedures for a given product.

In particular, known mixing apparatuses for food, pharmaceutical or cosmetic products comprise assemblies for attaching the mixing elements which provide for the use of screw and/or bolt elements. In this state, the maintenance/replacement and cleaning steps of the mixing elements are time-consuming and/or difficult because of the need to use one or more suitable tools. In addition, for some types of equipment, depending on the shape of the processing tank and the position of the mixing elements on the arms, it is likely that the use of the tools may be even more difficult.

In addition, especially in the food and pharmaceutical sectors, directives or voluntary standards of good manufacturing practice are being issued with the aim of increasing the safety of the products obtained and the use of the apparatuses, providing for components that may be easily disassembled and that have a reduced number of screw and/or bolt elements, or none at all.

For example, in the United States, NSF/ANSI 4:2020 provides for revisions that will establish additional minimum safety and sanitation requirements for the materials, design, construction and performance of commercial cooking, reheating and food preservation apparatuses and components.

In particular, the directive requires that no attachment assemblies comprising screw and/or bolt elements be used in regions in contact with the food product or, if they are provided, they must not have exposed threads and/or protruding screws.

It is reasonable to assume that similar regulations may be issued in other countries in the future, requiring that food, pharmaceutical or cosmetic mixing devices be made up of components that may be easily disassembled and have a reduced number of screw and/or bolt elements, or none at all, to meet the requirements of similar regulations or good manufacturing practice standards.

Therefore, it is necessary to find a solution that overcomes at least one of the drawbacks described above.

### SUMMARY OF THE INVENTION

The task of the present invention is to provide a mixing and/or scraping assembly for a mixing apparatus for food, pharmaceutical or cosmetic products which provides an effective construction suitable for reducing or eliminating screw and/or bolt elements.

In the context of the task set forth above, an object of the present invention relates to a mixing and/or scraping assembly which provides for easy operation, preferably without the use of tools for carrying out the assembly/disassembly steps.

Another object concerns a mixing and/or scraping assembly that provides a secure connection of a mixing and/or scraping element to mixing arms.

Another object concerns a mixing and/or scraping assembly that provides a construction that is easily cleaned and maintained.

Another object concerns a mixing and/or scraping assembly that provides an easily achievable construction.

Another object concerns a mixing and/or scraping assembly having a construction which may be widely varied at the design stage, for example according to the function and type of food product.

Another object concerns a mixing apparatus for food, pharmaceutical or cosmetic products which provides for the reduction or elimination of screw and/or bolt elements.

The foregoing task and objects, and others which will become more apparent in the following description, are accomplished by means of a mixing and/or scraping assembly as defined in the independent claim, and a mixing apparatus comprising the same. Preferred embodiments are defined in the dependent claims.

### BRIEF DESCRIPTION OF THE FIGURES

The additional features and advantages of the mixing and/or scraping assembly for a mixing apparatus for food, pharmaceutical or cosmetic products according to the present invention will become more apparent in the following description relating to embodiments given by way of non-limiting example only, with reference to the following figures, wherein:

FIG. 1 is a perspective view of a mixing apparatus comprising a mixing and/or scraping assembly, according to a preferred embodiment of the present invention;

FIG. 2 is the perspective view of the mixing apparatus in FIG. 1, in which some components are shown in transparency by hatching;

FIG. 3 is a perspective view of the mixing and/or scraping assembly in FIG. 1 in an assembled state;

FIG. 4 is a perspective view of the mixing and/or scraping assembly in FIG. 3 in a disassembled state in which a mixing and/or scraping element is disconnected from mixing arms by operating a releasable clamping mechanism;

FIG. 5 is an enlarged view of the mixing and/or scraping assembly in FIG. 3 at the releasable clamping mechanism in a first disassembly step;

FIG. 6 is an enlarged view of the mixing and/or scraping assembly in FIG. 3 at the releasable clamping mechanism in a second disassembly step;

FIG. 7 is an enlarged view of the mixing and/or scraping assembly in FIG. 4 at the releasable clamping mechanism in a third disassembly step;

FIG. 8 is an exploded perspective view of the mixing and/or scraping element and components of the releasable clamping mechanism;

FIG. 9 is a perspective view from below of the mixing and/or scraping element in FIG. 8 at the releasable clamping mechanism in a first step of attaching its components;

FIG. 10 is a bottom view of the mixing and/or scraping element in FIG. 8 at the releasable clamping mechanism in a second step of attaching its components;

FIG. 11 is a bottom view of the mixing and/or scraping element in FIG. 8 at the releasable clamping mechanism in a third step of attaching its components;

FIG. 12 is a bottom view of the mixing and/or scraping element in FIG. 8 at the releasable clamping mechanism in a fourth step of attaching its components;

FIG. 13 is a top view of the components of the releasable clamping mechanism and the mixing and/or scraping element in FIG. 8;

FIG. 14 is a side view of the components of the releasable clamping mechanism and the mixing and/or scraping element in FIG. 8.

### DETAILED DESCRIPTION OF THE INVENTION

The present invention relates to a mixing and/or scraping assembly for a mixing apparatus for food, pharmaceutical or cosmetic products. Preferably, said mixing apparatus is suitable for mixing products under room temperature conditions or before and/or during and/or after heat treatment, under pressure, under vacuum, under controlled atmosphere and similar, such as cooking in the case of certain types of food products. Such a treatment may be carried out by means of suitable devices associated with the mixing apparatus, such as heating, pressure generating, controlled atmosphere generating or vacuum generating devices and the like.

In the following description, reference will be made to a mixing apparatus for processing a food product by mixing and heat treatment, such as a mixing and cooking apparatus, which is suitable for cooking, boiling, braising, frying, pasteurizing, browning, sauteing, blanching, roasting, or the like, depending on the application. However, this reference should be understood only as a non-limiting example, since the mixing apparatus according to the present invention may be used for processing by mixing any food, pharmaceutical or cosmetic product by optionally providing for any type of heat and/or pressure and/or vacuum and/or controlled atmosphere and/or similar treatment.

Moreover, in the following description, terms such as “high,” “low,” “top,” “bottom” or similar refer to a mixing apparatus and a mixing and/or scraping assembly, according to the present invention, in the typical working set-up as depicted in the accompanying figures.

In addition, in the following description, the terms “mixing and/or scraping assembly” or “mixing and/or scraping element” refer to any assembly or element that is suitable for mixing and/or stirring and/or whipping and/or beating and/or scraping the food, pharmaceutical or cosmetic product.

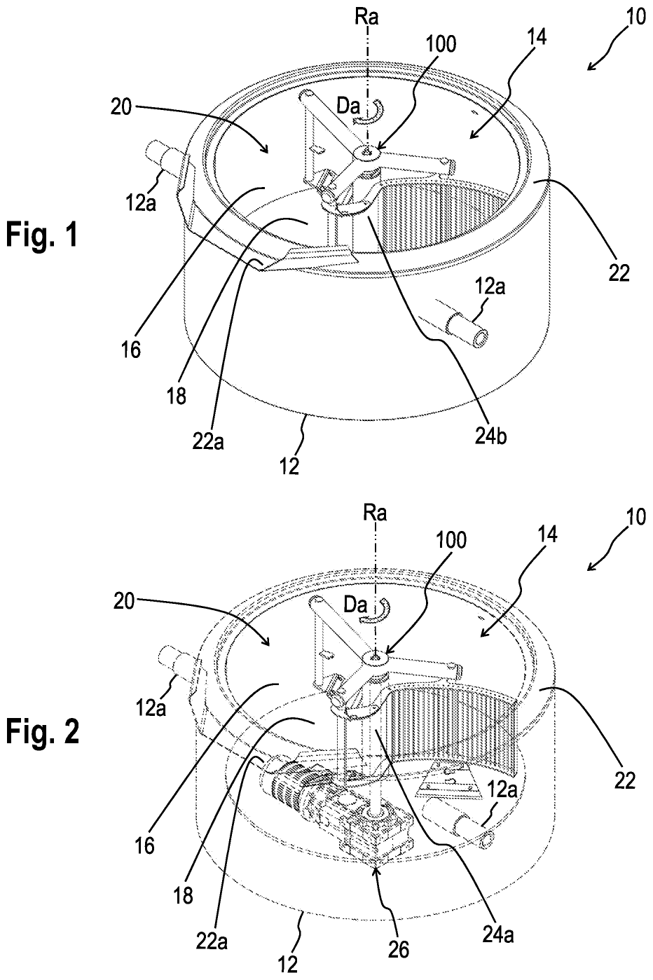

FIGS. 1 and 2 show a mixing apparatus 10 for food, pharmaceutical or cosmetic products, comprising a mixing and/or scraping assembly 100, according to a preferred embodiment of the present invention.

In the present embodiment, the mixing apparatus 10 is configured to mix and cook food products, such as, for example, an industrial cooker. However, as noted above, this selection is not limiting, and the mixing apparatus 10 may, for example, be configured to mix food products at room temperature or at low temperature.

The mixing apparatus 10 preferably comprises a housing 12 possibly provided with a floor support structure or any other desired horizontal support plane (not shown in the figures).

A processing tank 14 is disposed within the housing 12, preferably substantially cylindrical in shape having a side wall 16 connecting a bottom wall 18 and an opposing open upper base 20, the latter arranged substantially at an upper panel 22 of the housing 12.

The processing tank 14 is suitable for receiving the food product, such as a food or a mixture of several food ingredients having any solid, liquid, pasty or similar form, or combinations thereof. The housing 12 may be provided with a lid (not shown in the figures) suitable for reversibly closing the open upper base 20 of the processing tank 14.

The housing 12 further comprises a pair of pivot pins 12a, configured to rotate the processing tank 14 relative to the ground support structure, and a spout portion 22a disposed on the top panel 22 to channel the food product when it is poured from the processing tank 14 by rotation of the housing 12 about the pivot pins 12a.

In the present embodiment, the mixing apparatus 10 further comprises, within the housing 12, a heating unit (not shown in the figures), preferably operated by electricity, gas, direct or indirect steam, or the like, which is configured to heat the processing tank 14 and its contents by known systems, such as a combination of one or more resistor elements associated with the side 16 and/or bottom 18 walls, which are in turn driven by a power supply, preferably electronically controlled.

A rotating shaft 24a is disposed within the processing tank 14, preferably projecting upwardly from the bottom wall 18 through a tubular support element 24b at a position substantially coaxial with the processing tank 14. The rotating shaft 24a is rotatable about an assembly axis of rotation Ra, preferably coaxial with the axis of the processing tank 14, by means of a rotary drive assembly 26 (best seen in FIG. 2, where the housing 12 is shown in transparent form by hatching). The rotary drive assembly 26, for example comprising an electric motor or the like, is preferably located below the processing tank 14 near the bottom wall 18.

The mixing assembly 100 is housed in the processing tank 14 and is connected, preferably detachably, by suitable coupling means, to the rotary drive assembly 26 via the rotating shaft 24a to rotate integrally therewith about the assembly axis of rotation Ra. In a more preferred embodiment, the mixing and/or scraping assembly 100 is connected to the rotating shaft 24a by removable coupling means that may be manually operated without the use of tools.

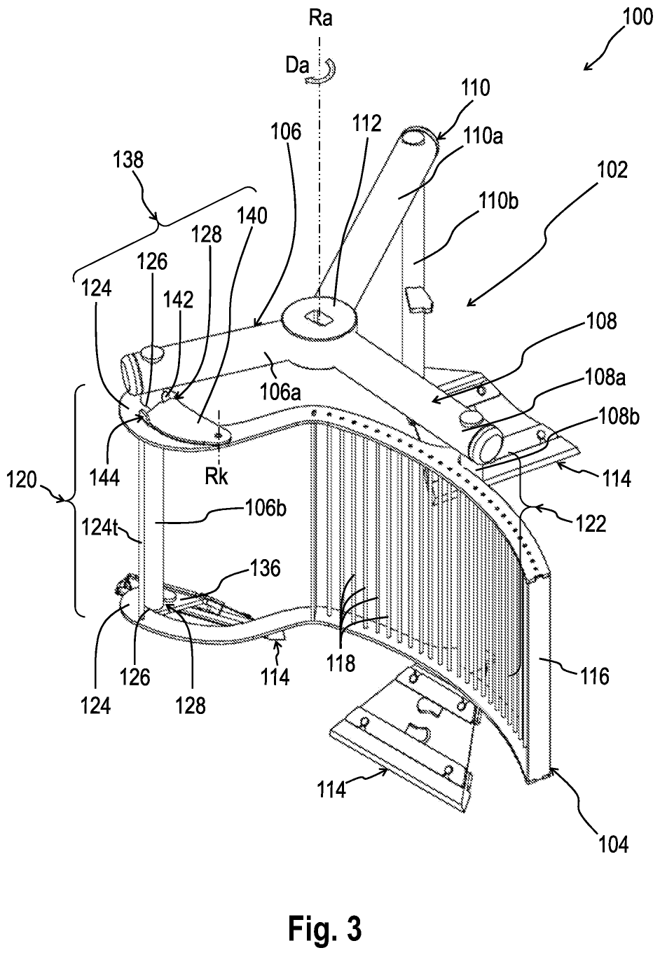

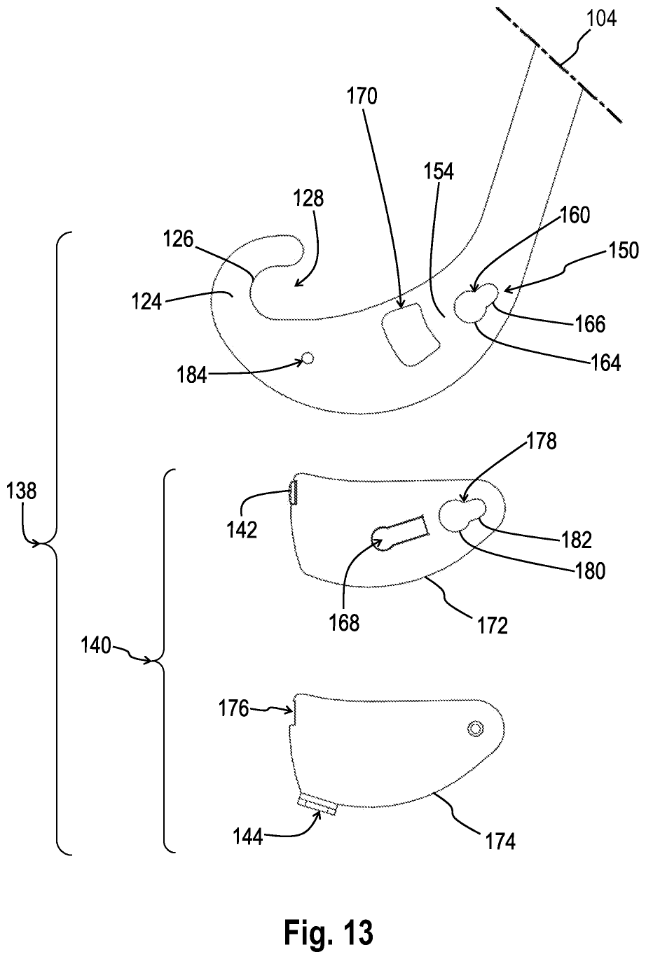

Referring specifically to FIG. 3 to 14, the mixing and/or scraping assembly 100 comprises a mixing arm assembly 102 and at least one mixing and/or scraping element 104 that are removably connectable to each other.

The mixing arm assembly 102 comprises a plurality of mixing arms, such as a first mixing arm 106, a second mixing arm 108 and a third mixing arm 110. However, this selection is not limiting, and the mixing arm assembly 102 may comprise any number of mixing arms greater than or equal to two.

The mixing arm assembly 102 is connectable to the rotary drive assembly 26 via the rotating shaft 24a so as to be operatively capable of rotating about the assembly axis of rotation Ra in a desired assembly direction of rotation Da (an illustrative assembly direction of rotation Da is shown in FIG. 1 to 4 by means of a thick dotted arrow, however, the assembly direction of rotation Da may provide for the opposite direction from that depicted).

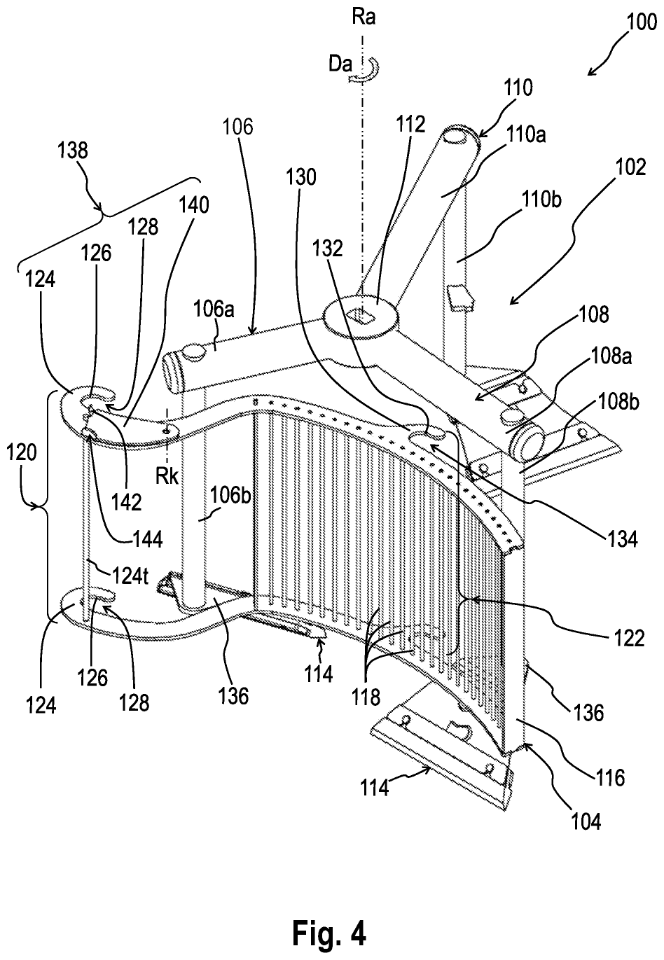

In the present embodiment, the mixing arm assembly 102 also comprises a hub element 112 (best seen in FIGS. 3 and 4) from which each of said first 106, second 108 and third 110 mixing arms preferably extend.

In particular, the hub element 112, having a substantially cylindrical shape and formed preferably of steel, is configured to be preferably removably attachable to the rotating shaft 24a of the mixing apparatus 10.

For this purpose, the hub element 112 may, for example, comprise a coupling seat (not numbered) adapted to be engaged by a coupling portion (not shown in the figures) of the rotating shaft 24a and to be attached thereto by a clamping element (not shown in the figures). For example, the coupling seat may be a rectangular through hole, and is also configured to be engaged by the coupling portion having a complementary shape, such as a rectangular-based projection, protruding from the upper end of the rotating shaft 24a along the direction of the assembly axis of rotation Ra. The clamping element, such as, for example, a threaded ferrule element, is configured to achieve, preferably manually and without the use of tools, the clamping of the hub element 112 on the rotating shaft 24a, i.e., on its coupling portion, which is potentially provided with a thread suitable for cooperating with the thread of the clamping element. However, it is apparent that the hub element 112 may provide for additional constructions and/or means for attaching to the rotating shaft 24a. For example, in further embodiments, the hub element 112 may be welded or formed in one piece with the rotating shaft 24a.

Said first 106, second 108 and third 110 mixing arms are formed preferably of steel and extend preferably cantilevered from the hub element 112 in angularly offset positions about the assembly axis of rotation Ra. In particular, the first 106, second 108 and third 110 mixing arms extend to potentially reach a desired proximity to the inner surface of the bottom 18, and/or side 16 walls of the processing tank 14. Preferably, each of the first 106, second 108 and third 110 mixing arms is configured to operatively reach a respective proximity zone of the bottom wall 18 that is different from that of the other mixing arms. In the present embodiment, the first 106, second 108 and third 110 mixing arms provide for a substantially inverted “L” shape having a first part, 106a, 108a and 110a, respectively, extending integral from the hub element 112 along a direction substantially orthogonal to the assembly axis of rotation Ra, and a second part, 106b, 108b and 110b, respectively, consecutive to the respective first part and bent about 90 degrees with respect to the latter, and therefore substantially parallel to the assembly axis of rotation Ra. However, it seems clear that the construction, shape and size of the first 106, second 108 and third 110 mixing arms and parts thereof may be selected as widely as needed. Potentially, the first 106, second 108 and third 110 mixing arms may be configured to be removably attachable to the hub element 112 through appropriate coupling assemblies. Alternatively, the first 106, second 108 and third 110 mixing arms may be made integral, for example by welding, to the hub element 112. According to a further alternative, the parts of each first 106, second 108 and third 110 mixing arm may be formed separately and subsequently made integral with each other, for example, by welding.

In the present embodiment, each first 106, second 108 and third 110 mixing arm comprises a respective scraping spatula 114 at its distal end with respect to the hub 112. Preferably, each scraping spatula 114 is attached by a respective quick-release attachment assembly. In particular, in the present embodiment, the scraping spatulas 114 are designed to contact, under operating conditions, the inner surface of the bottom 18 and/or side 16 walls of the processing tank 14, while at the same time scraping the food product as the mixing arm assembly 102 rotates. However, such scraping spatulas 114 may be provided at other parts of said first 106, second 108 and third 110 mixing arms, or they may be absent.

The mixing and/or scraping element 104 is removably attachable to the mixing arm assembly 102 by means of a quick-release attachment system, as further explained below.

In the present embodiment, said mixing and/or scraping element 104 is a mixing element formed, for example, of steel. Preferably, the mixing and/or scraping element 104 comprises a substantially rectangular and possibly curved frame 116 defining a central opening at which a grate element 118 is attached, the latter formed by a plurality of bars parallel and/or crossed to each other. The grate element 118 is appropriately configured to mix and/or stir and/or whip and/or beat the food product during the rotation of the mixing arm assembly 102 about the assembly axis of rotation Ra. However, this selection is not limiting, and the shape, construction, size and materials of the mixing and/or scraping element 104 and its components, such as the frame 116 and the grate element 118, may vary widely according to the function (mixing and/or stirring and/or whipping and/or beating and/or scraping and/or the like) and to the type of food product.

Said mixing and/or scraping element 104 may be coupled, i.e., removably connected, with at least two of said mixing arm assemblies 102, such as the first mixing arm 106 and the second mixing arm 108, through a substantially contact relationship. In particular, the mixing and/or scraping element 104 may be coupled, i.e., connected, to the first mixing arm 106 and the second mixing arm 108 by first anchoring means 120 and second anchoring means 122, respectively, preferably provided on said mixing and/or scraping element 104.

In the present embodiment, the first anchoring means 120 and the second anchoring means 122 have substantially similar constructions. However, further embodiments are possible in which the first anchoring means 120 and second anchoring means 122 provide for constructions that are different from each other and each suitable for removably coupling, i.e., connecting, the mixing and/or scraping element 104 with a respective one of said mixing arm assembly 102, such as the first mixing arm 106 and the second mixing arm 108.

The first anchoring means 120 are preferably provided at a first end region of the mixing and/or scraping element 104. First anchoring means 120 preferably comprise first hook means 124, such as a first pair of hook extensions 124 connected together by a cross element 124t, which define a respective first seat portion 126.

The first seat portion 126, defined in the present embodiment by each of the first pair of hook extensions 124, is configured to receive at least one part of the respective first mixing arm 106, such as the second part 106b, through a first receiving opening portion 128, also defined in the present embodiment by each of the first pair of hook extensions 124 of the first anchoring means 120.

Second anchoring means 122 are preferably provided at an intermediate portion between the first end region and an opposing second end region of the mixing and/or scraping element 104. Second anchoring means 122 preferably comprise second hook means 130, such as a second pair of hook extensions 130, which define a respective second seat portion 132 (the second anchoring means 122 are best seen in FIG. 4).

The second seat portion 132, defined in the present embodiment by each of the second pair of hook extensions 130, is configured to receive at least one part of the respective second mixing arm 108, such as the second part 108b, through a second receiving opening portion 134, also defined in the present embodiment by each of the second pair of hook extensions 130 of the second anchoring means 122.

Preferably, the mixing arm assembly 102 further comprises support means 136 configured to support, preferably in abutment, the mixing and/or scraping element 104 when the latter is coupled, i.e., connected, with the two first 106 and second 108 mixing arms by means of the first 120 and second 122 anchoring means.

In the present embodiment, the support means 136 are defined by two separate support plates, each extending to a respective first 106 and second 108 mixing arm at the ends distal with respect to the hub element 112. In particular, said support plates 136 preferably define respective attachment bases for said scraping spatulas 114. However, this configuration is not limiting, and the support means 136 may provide for additional constructions and/or positions with respect to the first 106 and second 108 mixing arms.

According to the present invention, at least one of said first 120 and second 122 anchoring means is provided with, or includes, a releasable clamping mechanism 138 comprising in turn said hook means of the respective first 120 and second 122 anchoring means and a clamping element 140. Said releasable clamping mechanism 138 is preferably provided on said mixing and/or scraping element 104.

In the present preferred embodiment, the first anchoring means 120 are equipped with said releasable clamping mechanism 138. However, additional embodiments may be provided in which the second anchoring means 122 are equipped with the releasable clamping mechanism 138, or both the first 120 and second 122 anchoring means are equipped with a respective releasable clamping mechanism 138.

Therefore, in the present preferred embodiment the releasable clamping mechanism 138, provided by the first anchoring means 120, comprises said clamping element 140 and said first hook means 124 which, as mentioned above, define, i.e., comprise, said first seat portion 126, which in turn is configured to receive at least one part of the respective mixing arm 106, such as the second 106b, through said first receiving opening portion 128.

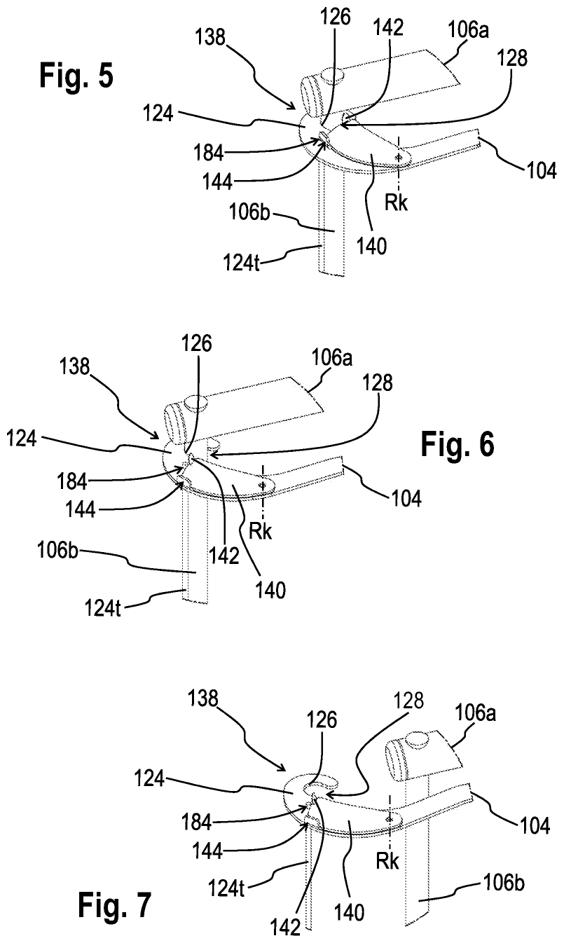

In particular, referring to FIG. 3 to 7, the clamping element 140, such as a plate element formed of steel and/or harmonic steel, is movable between a closed and an open position, preferably obtainable by manual operation. In the closed position, the clamping element 140 is adapted to engage at least partially said first receiving opening portion 128 so as to prevent the insertion into and withdrawal from said first seat portion 126 of the respective second part 106b of the first mixing arm 106 (see FIGS. 3 and 5) by attaching the mixing and/or scraping element 104 to the first 106 and second 108 mixing arms, of the mixing arm assembly 102. On the other hand, in the open position, the clamping element 140 is adapted to disengage, i.e., at least partially release, said first receiving opening portion 128 so as to allow insertion into and extraction from said first seat portion 126 of the respective second part 106b of the first mixing arm 106 (see FIGS. 4, 6 and 7), releasing, to allow for decoupling, the mixing and/or scraping element 104 from the first 106 and second 108 mixing arms of the mixing arm assembly 102.

Advantageously, with this construction, the mixing and/or scraping assembly 100 of the mixing apparatus 10 provides a construction suitable for reducing or eliminating screw and/or bolt elements and, at the same time, providing a secure connection of the mixing and/or scraping element 104 to the mixing arm assembly 102 by means of the releasable clamping mechanism 138.

Further, advantageously, with this construction the mixing and/or scraping assembly 100 of the mixing apparatus 10 provides for easy operation, particularly without the use of tools for assembly/disassembly. In fact, it is possible to intuitively and easily grasp the mixing and/or scraping element 104 with both hands and, with one hand, to operate the clamping element 140 to achieve the connection to or disconnection from the mixing arm assembly 102.

Consequently, with this construction, the mixing and/or scraping assembly 100 advantageously ensures simple cleaning and maintenance steps by being able to easily disconnect/connect the mixing and/or scraping element 104 with respect to the mixing arm assembly 102.

Moreover, this construction of the mixing and/or scraping assembly 100 advantageously ensures simple steps for manufacture as well as design. In particular, this construction allows the structure of the mixing and/or scraping element 104, frame 116 and grate element 118, for example, to vary widely according to the function, while at the same time ensuring a secure connection by means of the releasable clamping mechanism 138, the structure of which may be easily modified according to design needs.

Preferably, the clamping element 140 of the releasable clamping mechanism 138 is configured to be movable from said closed position to said open position, and vice versa, by rotating it about a clamping element axis of rotation Rk. Preferably, the movement between said closed and open positions is achieved by rotations in opposite directions with rotation angles less than or equal to 90 degrees, more preferably less than or equal to 45 degrees. In a more preferred embodiment, said clamping element axis of rotation Rk is, under operating conditions, substantially parallel to the assembly axis of rotation Ra about which the mixing arm assembly 102 rotates.

Advantageously, a construction that provides a rotary movement of the clamping element 140 to achieve said closed and open positions in the releasable clamping mechanism 138 is simple and intuitive to use, as well as compact and easy to construct.

Furthermore, in a mixing apparatus 10 in which the assembly axis of rotation Ra is arranged along a vertical direction with respect to the horizontal support plane, a construction in which the clamping element axis of rotation Rk is parallel to the assembly axis of rotation Ra advantageously makes it possible to reduce the likelihood that the steps of filling the processing tank 14 with food product (typically introduced by gravity through the open upper base 20) may induce a movement of the clamping element 140 from the closed position to the open position, undesirably disconnecting the mixing and/or scraping element 104 from the mixing arm assembly 102. Therefore, in this state, a more reliable and secure attachment of the mixing and/or scraping element 104 to the mixing arm assembly 102 is ensured.

Preferably, the releasable clamping mechanism 138 further comprises first retaining means 142 that are suitable for reversibly retaining the clamping element 140 in said closed position when the mixing and/or scraping element 104 is coupled, i.e., connected, with the first 106 and second 108 mixing arms.

Advantageously, in this state, a more reliable and secure connection of the mixing and/or scraping element 104 to the mixing arm assembly 102 is ensured.

In the present embodiment, said first retaining means 142 are resilient retaining means 142. Preferably, said resilient retaining means 142 are adapted to cooperate with the respective mixing arm, such as the first mixing arm 106, by means of a contact relationship to retain the clamping element 140 in said closed position when the mixing arm 106 is received in the respective seat portion 126.

In particular, in this embodiment said resilient retaining means 142 are configured so that the movement of the clamping element 140 from the closed position to the open position, and vice versa, is achieved by applying, preferably manually, an opening/closing force that exceeds a frictional force between said resilient retaining means 142 and said respective mixing arm 106.

For this purpose, for example, the resilient retaining means 142, preferably formed as a tab element made of steel or harmonic steel, are formed protruding from an upper surface of the clamping element 140 and are configured to be in a contact relationship with the first mixing arm 106, or its second part 106b, when the clamping element 140 is in the closed position.

Further, the resilient retaining means 142 are preferably formed inclined with respect to both the direction parallel and orthogonal to an extension direction of the second part 106b of the first mixing arm 106 on which they act, i.e., preferably inclined with respect to both the direction parallel and orthogonal to the assembly axis of rotation Ra and the clamping element axis of rotation Rk.

In particular, the resilient retaining means 142 are capable of exerting a resilient force, induced by a resilient deformation thereof, when they cooperate with the second part 106b of the first mixing arm 106 and the clamping element 140 is in said closed position. Therefore, in this state, in order to move the clamping element 140 from the closed position to the open position, and vice versa, it is necessary to apply, preferably manually, an opening/closing force that exceeds the frictional force (obtained from the resilient deformation) between the resilient retaining means 142 and the respective mixing arm 106, or the second part 106b thereof.

Advantageously, such a construction provides another more reliable and secure connection of the mixing and/or scraping element 104 to the mixing arm assembly 102 and, in addition, is particularly simple and intuitive to use.

Moreover, advantageously, with such a construction it is possible to hold the clamping element 140 in the closed position by means of resilient retaining means 142, and thus the use of screw and/or bolt elements is substantially reduced.

In particular, the embodiment involving resilient retaining means 142 formed of harmonic steel ensures that the releasable clamping mechanism 138 is reliable to operate even after a large number of opening and closing cycles of the clamping element 140.

Potentially, the releasable clamping mechanism 138 may comprise second retaining means (not shown in the figures) that are suitable for reversibly retaining the clamping element 140 in said closed position when the mixing and/or scraping element 104 is coupled, i.e., connected, with the first 106 and second 108 mixing arms.

Advantageously, in this state, a more reliable and secure connection of the mixing and/or scraping element 104 to the mixing arm assembly 102 is ensured.

For example, said second retaining means may be interlocking retaining means (not shown in the figures) that include a first interlocking element (not shown in the figures) provided on the first hook means 124, and a second interlocking element (not shown in the figures) provided on the clamping element 140. In particular, said first and second interlocking elements may be configured to cooperate with each other by contact, interlocking, friction, or similar relationship to hold the clamping element 140 in said closed position when the mixing arm 106 is received in the respective seat portion 126.

Advantageously, such a possible construction provides a further more reliable and secure connection of the mixing and/or scraping element 104 to the mixing arm assembly 102 and, in addition, does not substantially provide for screw and/or bolt elements.

Preferably, the clamping element 140 further comprises actuation and manipulation means 144 that are suitable for facilitating manual actuation of the clamping element 140 between said closed and open positions.

In the present embodiment, said actuation and manipulation means 144 are preferably defined as a fin element formed protruding from a portion of the clamping element 140, such as an edge thereof, and configured to be operable with at least one finger of one hand. In the most preferred embodiment said actuation and manipulation means 144 are defined by a fin element extending at least partially parallel to the clamping element axis of rotation Rk and at a position distal from the latter to achieve an effective leverage effect.

Advantageously, with this construction, the releasable clamping mechanism 138 provides for further simple and intuitive operation since it is possible to grasp the mixing and/or scraping element 104 with both hands and, with the fingers of either hand, operate the clamping element 140 to achieve connection to or disconnection from the mixing arm assembly 102. In particular, the actuation and manipulation means 144 improve the ergonomics of the clamping element 140 by allowing pressure to be conveniently applied to achieve movement between said closed and open positions.

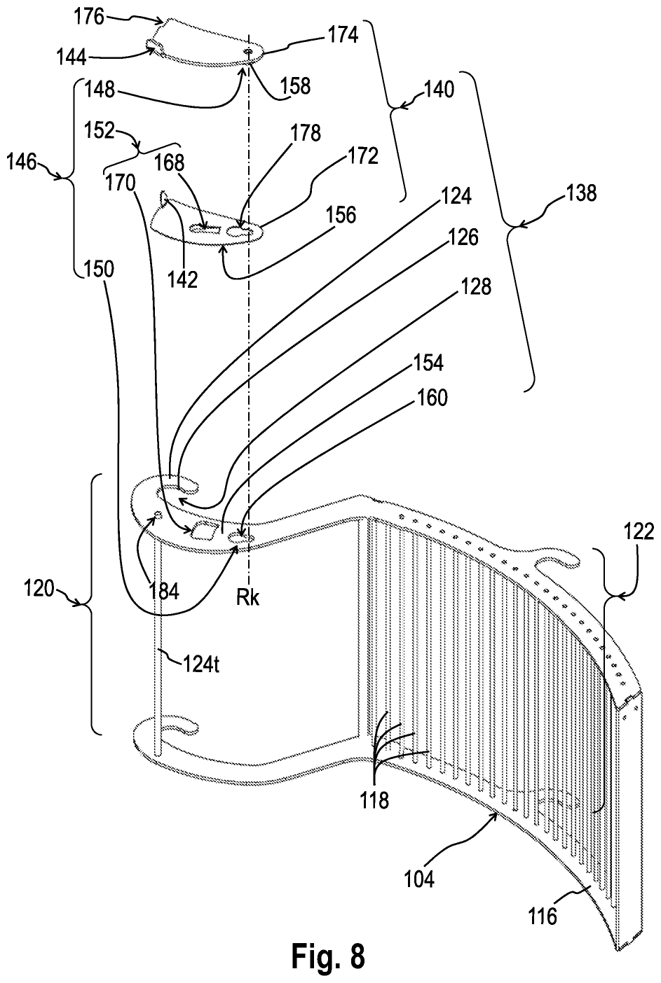

Referring in particular to FIG. 8 to 14, the mixing and/or scraping assembly 100 preferably has a construction in which the clamping element 140 is provided distinct from the mixing and/or scraping element 104 and is further configured to be removably attachable to the latter by releasable attachment means 146, optionally by releasable snap attachment means 146.

Advantageously, this construction allows simple cleaning and maintenance steps for the mixing and/or scraping assembly 100 because it is possible to conduct these steps on the mixing and/or scraping element 104 and/or the clamping element 140 independently of each other, separating them.

In the present embodiment, said releasable attachment means 146 preferably comprise first rotatable connection means 148 provided on said clamping element 140, second rotatable connection means 150 provided on said mixing and/or scraping element 104, and a resilient clamping assembly 152.

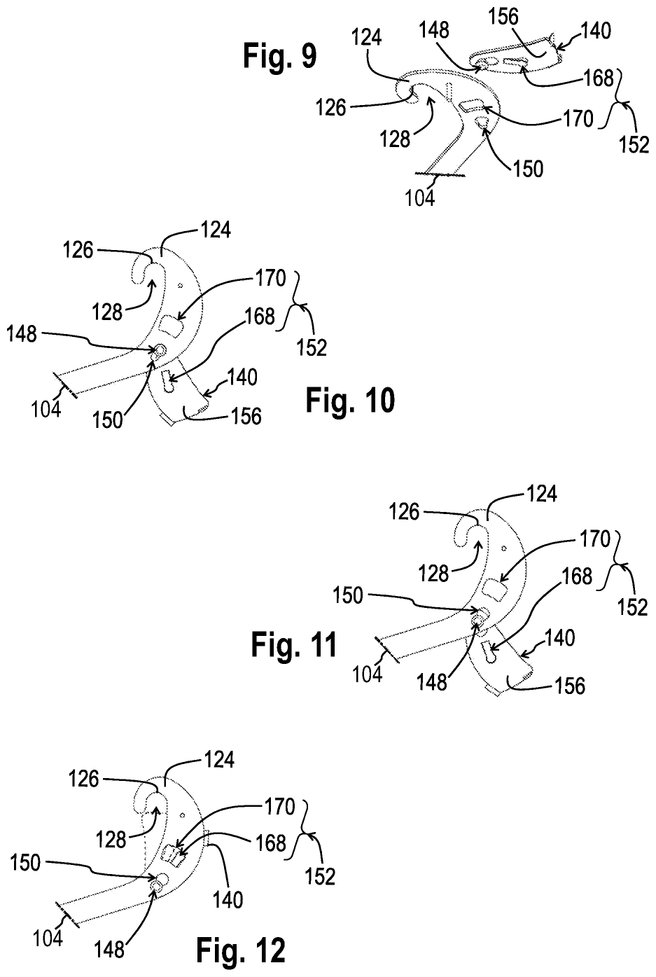

The first rotatable connection means 148 and the second rotatable connection means 150 are suitable to be removably coupled to each other through successively a first reversible insertion position (see FIGS. 9 and 10) and a second rotatable attachment position (see FIGS. 11 and 12), and vice versa. In the first reversible insertion position said first 148 and second 150 rotatable connection means are at least partially engaged with each other, e.g., at least partially mutually inserted. On the other hand, in the second rotatable attachment position said first 148 and second 150 rotatable connection means are engaged with each other by a rotatable contact relationship to connect the clamping element 140 to the mixing and/or scraping element 104 so that said clamping element 140 is movable between said closed and open positions.

The resilient clamping assembly 152 is configured to be movable, preferably by manual actuation, between a rest position in which the first 148 and second 150 rotatable connection means are clamped in said second rotatable connection position, and a stressed position, obtained by resilient deformation, in which said first 148 and second 150 rotatable connection means are free to, i.e., are suitable to, move from said second rotatable attachment position to said first reversible insertion position, and vice versa.

Advantageously, such a construction ensures an attachment of the clamping element 140 to the mixing and/or scraping element 104 by releasable attachment means 146 that do not provide for screw and/or bolt elements.

In the present embodiment, the mixing and/or scraping element 104 comprises a sliding portion 154 operatively suitable for receiving in an overlapping relationship said clamping element 140 through contact with a first face 156 thereof.

For example, the sliding portion 154 is an upper surface region of one of the two hook extensions defining the first hook means 124, and is suitable for receiving, substantially by sliding contact, the first face 156 of said clamping element 140 when it is moved, i.e., when it is rotated, from the closed position to the open position, and vice versa.

Further, in the present embodiment said first rotatable connection means 148 comprise an attachment-and-pivot pin 158, while said second rotatable connection means 150 comprise a through engagement opening 160.

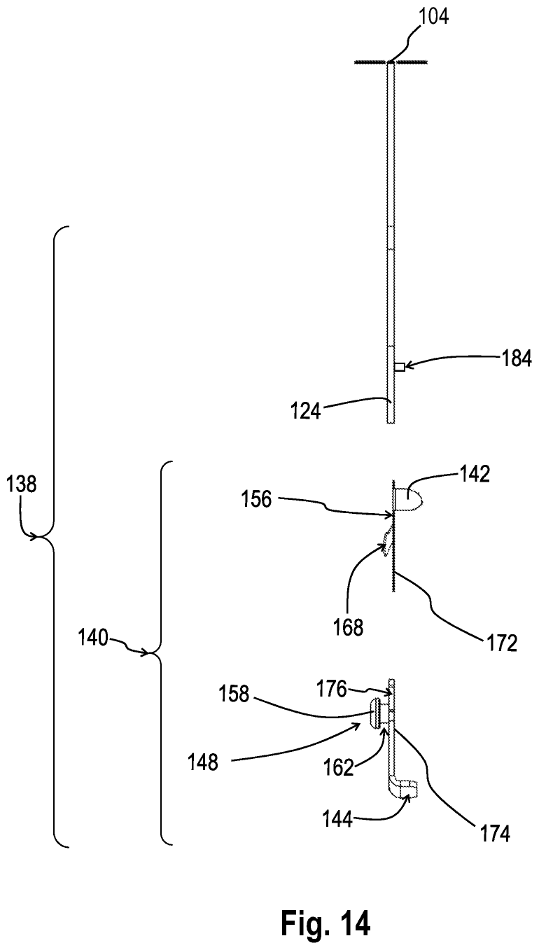

In particular, the attachment-and-pivot pin 158 extends protruding from the first face 156 of the clamping element 140 and provides for a small-diameter portion 162 (best seen in FIG. 14) having a smaller outer diameter than the other portions thereof. The small-diameter portion 162, moreover, is formed in a portion having a predetermined height and separated from the free end of the attachment-and-pivot pin 158, i.e., separated from the end that is distal to the first face 156.

In addition, the engagement through opening 160, which is substantially slot-shaped, is formed at said sliding portion 154 and comprises a first opening portion 164 and a second opening portion 166 that are continuous with each other. The first opening portion 164 has an inner diameter larger than the inner diameter of the second opening portion 166. In particular, the first opening portion 164 has an inner diameter suitable for receiving said attachment-and-pivot pin 158, while the second opening portion 166 has an inner diameter substantially corresponding to the outer diameter of said small-diameter portion 162 so as to receive the latter in said second rotatable attachment position of the first 148 and second 150 rotatable connection means defining the clamping element axis of rotation Rk of the clamping element 140.

Also, in the present embodiment, said resilient clamping assembly 152 comprises a resilient clamping body 168 and an engagement through hole 170.

The resilient clamping body 168, preferably formed of harmonic steel, is preferably provided on said clamping element 140, and is movable between said rest position in which it is protruding from the first face 156, and said stressed position, obtained by resilient deformation, in which it is flush with the first face 156.

The engagement through hole 170 is preferably formed on the sliding portion 154 so as to operatively receive the elastic clamping body 168 in said rest position when the first 148 and second 150 rotatable connection means are in said second rotatable attachment position (see FIG. 12).

In particular, the resilient clamping body 168 in said rest position and the engagement through hole 170 are configured and positioned to cooperate with each other so as to clamp the first 148 and second 150 rotatable connection means in said second rotatable attachment position, while at the same time allowing the movement of the clamping element 140 from the closed to the open position, and vice versa (see FIG. 12 in which the closed and open positions of the clamping element 140 are shown by dashed lines and solid lines, respectively). In other words, the through hole 170 is shaped by defining an opening region, substantially rectangular and arcuate in shape, to receive the resilient clamping body 168 in said rest position when the clamping element 140 is moved between the closed and open positions and, additionally to clamp the first 148 and second 150 rotatable connection means in said second rotatable attachment position. Preferably, the through hole 170 is shaped by defining an opening region suitable for receiving the resilient clamping body 168 in said rest position and limiting the movement by means of abutment with the latter, i.e., the rotation of the clamping element 140 between two limit positions defining respectively said closed and open positions (see FIG. 12 in which the closed and open positions of the clamping element 140 are shown by dashed lines and solid lines, respectively).

Advantageously, in this state, the mixing and/or scraping assembly 100 provides for a construction suitable for reducing or eliminating screw and/or bolt elements and, at the same time, provides simple operation. In particular, releasable attachment means 146 ensure the operability of the clamping element 140 and, at the same time, simple and intuitive steps for attaching and disconnecting the latter to facilitate easy cleaning and/or maintenance of the mixing and/or scraping assembly 100.

In particular, the embodiment providing for the resilient clamping body 168 formed of harmonic steel ensures reliability of operation of the releasable clamping mechanism 138 even after a large number of clamping and disconnection cycles of the clamping element 140 by the releasable clamping means 146.

Preferably, the releasable clamping mechanism 138 further comprises abutment means 184 that are suitable for cooperating, by means of abutment, with a portion of the clamping element 140 so as to maintain the first 148 and second 150 rotatable connection means in said second rotatable attachment position when the clamping element 140 is moved between said closed and open positions.

Preferably, the abutment means 184 are also adapted to cooperate, by abutment, with a portion of the clamping element 140 to at least partially guide said clamping element and the releasable attachment means 146 so that, when the first 148 and second 150 rotatable connection means are moved from said first reversible insertion position to said second rotatable attachment position, in the latter position the engagement through hole 170 of the resilient clamping assembly 152 is suitable for adequately receiving the resilient clamping body 168 in the rest position.

Potentially, in the most preferred embodiment, the abutment means 184 are also configured, i.e., positioned, to cooperate, by abutment, with a portion of the clamping element 140, such as the actuation and manipulation means 144, so as to limit to a single direction (clockwise or counterclockwise) the rotation of the clamping element 140 to obtain said second rotatable attachment position.

Advantageously, in this state, proper operation of the releasable clamping mechanism 138 and of the clamping element 140 is reliably ensured.

In the present embodiment, said abutment means 184 are defined by an projecting element protruding from an upper surface of the hook means 124, and are configured and positioned so as to prevent, i.e., interfere with, the movement of the first 148 and second 150 rotatable connection means from the second rotatable attachment position to the first reversible insertion position when the clamping element 140 is moved between said closed and open positions.

In the present most preferred embodiment, the clamping element 140 comprises a first body 172 and a second body 174 provided separate and operatively overlapping each other so that the first body 172 defines said first face 156 and is interposed between the second body 174 and the sliding portion 154.

In particular, the first body 172 and second body 174, as plate elements, when overlapping, are engaged, i.e., aligned, with each other by coupling between a projecting portion and a recessed portion 176 alternately provided on one of said first body 172 and said second body 174. Said projecting portion may provide for different configurations and, for example, may be defined by the same resilient retaining means 142 described above, or it may be defined by an additional tab or similar element.

Preferably, the second body 174 comprises the attachment-and-pivot pin 158, while the first body 172 comprises said resilient clamping body 168 and an engagement through slot 178.

The engagement through slot 178, which is substantially shaped like a buttonhole, comprises a first slot portion 180 and a second slot portion 182 that are continuous with each other. The first slot portion 180 has a larger inner diameter than the inner diameter of the second slot portion 182. In particular, the first slot portion 180 has an inner diameter suitable for receiving the rotation pin 158, while the second slot portion 182 has an inner diameter substantially corresponding to the outer diameter of said small-diameter portion 162 so as to receive the latter at said second rotatable attachment position of the first 148 and second 150 rotatable connection means defining the clamping element axis of rotation Rk of the clamping element 140.

Advantageously, this construction ensures simplicity in manufacturing the clamping element 140 and, at the same time, wide design possibilities thereof. In fact, at the design stage it is possible to broadly select features, such as shape and materials, of each first 172 and second 174 body as needed. For example, the first body 172, comprising the resilient clamping body 168, obtained by notching and bending a part of the plate element, and the resilient retaining means 142, obtained by bending a part of the plate element, may be formed with a first material that provides reliable springback features, such as harmonic steel. On the other hand, the second body 174 may be formed with a second material selected based on other features, such as high strength or lower cost than the first material. In this state, an effective combination of features of different materials may then be achieved.

In a particularly preferred embodiment, the releasable clamping mechanism 138 further comprises demarcation means (not shown in the figures) that are suitable for providing a user with information about obtaining, i.e., reaching, said closed position of the clamping element 140.

Said demarcation means may provide for any desired configuration, such as one or more graphic symbols, one or more inscriptions, or similar, which are obtained possibly by printing, engraving, or similar. For example, the demarcation means may be a graphic symbol, possibly depicting a closed padlock, that is formed on a portion of the surface of the hook means 124, such as the sliding portion 154. In particular, in this example, the demarcation means may be configured to be fully visible when the clamping element 140 is in said closed position, and non-visible or partially visible, i.e., covered, when the clamping element 140 is in said open position or in a position intermediate between the open and closed positions, respectively.

Advantageously, in this state, the releasable clamping mechanism 138 turns out to be particularly simple and intuitive to operate, providing unambiguous visual information to the user regarding the closed status of the clamping element 140.

It is evident how additional embodiments of the mixing and/or scraping assembly 100 are possible relative to that which has been described so far, without departing from the claimed scope of protection.

In fact, in the above description, the first hook means 124 are substantially defined by a first pair of hook extensions 124 connected by a crossbar element 124t. However, the first hook means 124 may provide for additional constructions, such as a single hook structure formed with a single plate element that is folded back on itself in a “U” shape so as to define a seat portion 126 that is configured to receive at least a part of the respective mixing arm through a receiving opening portion 128.

Further, with respect to the foregoing description, it appears clear that the mixing element 104, its frame 116 and its grate element 118, may provide for additional shapes, structures, sizes, and materials depending on the function (mixing and/or stirring and/or whipping and/or beating and/or scraping and/or similar) and the type of food product.

Further, with respect to the foregoing description, it appears clear that the mixing apparatus 10 may provide for a plurality of mixing elements 104 removably attachable to the mixing arm assembly 102 by respective anchoring means and releasable clamping mechanisms 138 according to the present invention.

Also, in the foregoing description, the mixing element 104 is connected to two first 106 and second 108 mixing arms, which are in turn rotatably associated, through the hub element 112, with a common tubular support element 24b within which the rotating shaft 24a of the mixing apparatus 10 rotates. However, it is possible to envisage an embodiment in which said mixing and/or scraping assembly 100 comprises said tubular support element 24b or said rotating shaft 24a which, in turn, serves as, i.e. defines, substantially a further mixing arm to which said mixing and/or scraping element 104 is removably coupled by respective further anchoring means, possibly provided with the latter having a respective releasable clamping mechanism 138 according to the present invention. In other words, it is possible to provide an embodiment in which the mixing and/or scraping element 104 may be coupled to the first mixing arm 106 by means of the first anchoring means 120 provided with the releasable clamping mechanism 138, and to the tubular support element 24b or the rotating shaft 24a by the second anchoring means 122.

From that which has been described so far, it is evident how important achievements have been made, overcoming the drawbacks of the state of the art, making it possible to create a mixing and/or scraping assembly 100 for a mixing apparatus 10 for food, pharmaceutical or cosmetic products, which provides for an effective construction suitable for reducing or eliminating screw and/or bolt elements.

Further, the scraping and/or mixing assembly 100 provides for easy operation, preferably without the use of assembly/disassembly tools. In fact, the releasable clamping mechanism 138 substantially operates as a quick-release attachment assembly that ensures simple manipulation and intuitive operation.

Further, the mixing and/or scraping assembly 100 securely connects the mixing and/or scraping element 104 to the mixing arm assembly 102. In fact, the releasable clamping mechanism 138, particularly through the clamping element 140, ensures a secure clamping.

In addition, the mixing and/or scraping assembly 100 provides a construction that is easy to manufacture, maintain and clean. In fact, the releasable clamping mechanism 138 provides for components having constructions that are easy to manufacture, maintain and clean.

Further, the construction of the mixing and/or scraping assembly 100 may be widely varied at the design stage according to the function of the mixing and/or scraping element 104 (mixing and/or stirring and/or whipping and/or beating and/or scraping and/or the like) and the type of food product.

Naturally, the materials and equipment used in the manufacture of the present invention, as well as the shape and size of the individual components, may be the most suitable according to specific requirements.

1. Mixing and/or scraping assembly for a mixing apparatus for food, pharmaceutical or cosmetic products, including:
a mixing arm assembly comprising a first mixing arm and a second mixing arm,
the mixing arm assembly being operatively suitable for rotating about an assembly axis of rotation, and
at least one mixing and/or scraping element that is removably connectable to the mixing arm assembly,
the mixing and/or scraping element is removably couplable with at least the first mixing arm and the second mixing arm by respective first anchoring means and second anchoring means, wherein
at least one of the anchoring means includes a releasable clamping mechanism provided on the mixing and/or scraping element,
the releasable clamping mechanism comprising:
hook means comprising a seat portion configured to receive at least one part of the respective mixing arm through a receiving opening portion, and
a clamping element movable between a closed position wherein it is suitable for at least partially engaging the receiving opening portion so as to prevent insertion in and extraction from the seat portion of the respective part of the mixing arm, and an opening position wherein it is suitable for disengaging at least partially the receiving opening portion so as to allow the insertion in and extraction from the seat portion of the respective part of the mixing arm.

2. The mixing and/or scraping assembly according to claim 1, wherein the clamping element is configured to be movable from the closed position to the open position, and vice versa, by rotation about a clamping element axis of rotation optionally operatively parallel to the assembly axis of rotation.

3. The mixing and/or scraping assembly according to claim 1, wherein the releasable clamping mechanism further comprises retaining means suitable for reversibly retaining the clamping element in the closed position when the mixing and/or scraping element is coupled with the mixing arms.

4. The mixing and/or scraping assembly according to claim 3, wherein the retaining means comprise resilient retaining means provided on the clamping element and suitable for cooperating with the respective mixing arm by a contact relationship to retain the clamping element in the closed position, wherein
the resilient retaining means are configured so that the movement of the clamping element from the closed position to the open position, and vice versa, is achieved by applying an opening/closing force that exceeds a frictional force between the resilient retaining means and the respective mixing arm.

5. The mixing and/or scraping assembly according to claim 1, wherein the clamping element is attachable removably to the mixing and/or scraping element by releasable attachment means, optionally by releasable snap attachment means.

6. The mixing and/or scraping assembly according to claim 5, wherein the releasable attachment means comprise first rotatable connection means provided on the clamping element, and second rotatable connection means provided on the mixing and/or scraping element,
the first rotatable connection means and the second rotatable connection means being removably couplable to each other through successively a first reversible insertion position and a second rotatable attachment position, and vice versa, wherein
in the first reversible insertion position the rotatable connection means are at least partially engaged with each other, and in the second rotatable attachment position the rotatable connection means are engaged with each other by a contact relationship to mutually connect the mixing and/or scraping element to the clamping element so that the latter is movable between the closed and open positions,
the releasable attachment means further comprising a resilient clamping assembly movable between a rest position, in which the rotatable connection means are clamped in the second rotatable attachment position, and a stressed position, in which the rotatable connection means are free to move from the second rotatable attachment position to the first reversible insertion position, and vice versa.

7. The mixing and/or scraping assembly according to claim 6, wherein the mixing and/or scraping element comprises a sliding portion suitable for operatively receiving in an overlapping relationship the clamping element through contact with a first face thereof,
the first rotatable connection means comprising:
an attachment-and-pivot pin extending projecting from the first face of the clamping element, the attachment-and-pivot pin providing for a small-diameter portion having a smaller outer diameter than other portions thereof, and formed in a portion having a predetermined height,
the second of rotatable connection means comprising:
an engagement through opening formed on the sliding portion and comprising a first opening portion and a second opening portion continuous therebetween, the first opening portion having an inner diameter suitable for receiving the attachment-and-pivot pin and the second opening portion having an inner diameter substantially corresponding to the outer diameter of the small-diameter portion so as to receive the latter in the second rotatable attachment position of the rotatable connection means defining a clamping element axis of rotation of the clamping element, and
the resilient clamping assembly comprising:
a resilient clamping body provided on the clamping element, the resilient clamping body being movable between the rest position where it is protruding from the first face, and the stressed position where it is flush with the first face,
an engagement through hole formed on the sliding portion so as to receive the resilient clamping body in the rest position when the rotatable connection means are in the second rotatable attachment position, wherein
the resilient clamping body in the rest position and the engagement through hole are also configured and positioned to cooperate with each other so as to clamp the rotatable connection means in the second rotatable attachment position.

8. The mixing and/or scraping assembly according to claim 7, wherein the clamping element comprises a first body and a second body operatively overlapping each other so that the first body defines the first face and is interposed between the second body and the sliding portion,
the second body comprising the attachment-and-pivot pin,
the first body comprising the resilient clamping body and an engagement through slot comprising a first slot portion and a second slot portion continuous therebetween, the first slot portion having an inner diameter suitable for receiving the attachment-and-pivot pin and the second slot portion having an inner diameter substantially corresponding to the outer diameter of the small-diameter portion so as to receive the latter in the second rotatable attachment position of the rotatable connection means defining a clamping element axis of rotation of the clamping element.

9. The mixing and/or scraping assembly according to claim 6, wherein the releasable clamping mechanism further comprises abutment means that are suitable for cooperating with a portion of the clamping element so as to maintain the rotatable connection means in the second rotatable attachment position when the clamping element moves between the closed and open positions.

10. The mixing and/or scraping assembly according to claim 1, wherein the releasable clamping mechanism further comprises demarcation means suitable for providing a user with information on reaching the closed position of the clamping element.

11. A mixing apparatus for food, pharmaceutical or cosmetic products comprising a rotary drive assembly configured to connect to and to rotate a mixing and/or scraping assembly according to claim 1, and to cause the latter to rotate about an assembly axis rotation.
